(19) United States
(12) Patent Application Publication
(10) Pub. No.: US 2026/0316104 A1
(43) Pub. Date: Oct. 15, 2026

(54) A PRISM SHAPED SPRAY BOTTLE

(71) Applicant: Koenigsegg Automotive AB, Ängelholm (SE)

(72) Inventor: Sebastian VON KOENIGSEGG, VEJBYSTRAND (SE)

(73) Assignee: Koenigsegg Automotive AB, Ängelholm (SE)

(21) Appl. No.: 19/484,742

(22) PCT Filed: May 15, 2024
(86) PCT No.: PCT/EP2024/063354

§ 371 Date: Nov. 14, 2025

(30) Foreign Application Priority Data
May 15, 2023 (EP) 23173424.5

(51) Int. Cl. B05B 11/10

(52) U.S. Cl. CPC B05B 11/1059; B05B 11/1047

(57) ABSTRACT

A spray bottle comprising—a bottle forming an interior space for holding a fluid, and—a spray head comprising a nozzle, configured to spray the fluid contained in the bottle, wherein the bottle has a bottom side configured for placement on a horizontal surface, and an oppositely arranged top side, and a finish, or spray head interface, attached to the top side, wherein the spray head is a manually operated pump spray head and comprises a trigger actuator configured to move from a first position to a second position to spray fluid from the interior space through the nozzle at the transition from the first position to the second position, and wherein the spray head is mounted, or connected, to the finish, or spray head interface, of the bottle, wherein the spray head is rotatable relative to the bottle to at least a first orientation in which the trigger actuator is prevented by the top side, to transition from the first position to the second position, and at least a second orientation in which the trigger is allowed to transition from the first position to the second position.

### TECHNICAL FIELD

The present invention relates to the technical field of spray bottles, comprising a container in the form of a bottle, wherein the bottle is provided with a spray head arranged on the bottle for spraying the fluid from the bottle by activation of a spray head trigger.

### BACKGROUND

Spray bottles are widely known and used in the world, for containing and upon actuation of a trigger on the spray head, spray, or mist, a portion of the contained fluid from a spray head nozzle. Such a spray head is also referred to as a trigger-style spray head. Spray bottles are often used for containing water-based cleaning detergents, and spraying a limited amount of the contained fluid from the bottle and apply the fluid to a desired surface or object. The spray bottle thus both apply and dose a predetermined amount for each actuation of the spray head trigger actuator.

Spray bottles are commonly used in the field of car, or vehicle, cleaning also referred to as car detailing. Car detailing involves cleaning of outer surfaces, such as the car body or panels, wheels, and windows as well as car internal surfaces, such as the dash, textile surfaces of seats and carpets.

Some fluids used during car detailing are applied for a limited time before the fluid is rinsed off. If the fluid is left on a vehicle surface for a prolonged time, the fluid may negatively affect, or degrade the surface. The fluid may thus sometimes be aggressive on different surface materials on or inside a vehicle.

Car detailing often involves the use of a plurality of different fluids, each configured for being applied to a specific surface or material.

One problem with commonly available spray bottles occur during the transport and storage of spray bottles in vehicles. During transport of spray bottles inside a vehicle, such as in the boot, or trunk, there is a high risk of leakage from the spray head nozzle. Due to the sometimes-aggressive nature of the fluid leaking, the boot liner may be soaked in the fluid and damaged, including discolored. This also applies to other areas, compartments or parts of the interior of a car, such as seats or interior carpet. For example, when a bag, containing spray bottles, is positioned in the backseat, or passenger seat, and one or more spray bottles leak, the damage to the seat may result in the need to completely re-upholster the car seat to return the seat to its original state.

One solution to leaking spray bottles is to equip the spray bottles with a leakage preventing valve. The leakage valve is integrated with the spray bottle, often arranged close to the spray nozzle and is configured to be positioned in a first and a second position. In the first position, the valve blocks fluid from leaking when the spray head actuator is pressed, and in the second position, spraying of fluid from the spray bottle, and spray head is permitted.

The valve thus provides some protection from spray bottle fluid leakage, however, the addition of the valve increases the production costs of the spray head. In addition, it is hard to visually distinguish a valve in its first position from its second position. This raises the risk that a spray bottle with an open valve is transported leading to an increased risk of leakage and damage to a car interior.

Accordingly, there is a need for an improved spray bottle, for use in car detailing, that reduces the risk of spray fluid leakage during transport and storage.

### OBJECT

The proposed technology aims at obviating the aforementioned disadvantages and failings of previously known spray bottle devices. It is an object of the invention to provide a spray bottle that reduces the risk of leakage during transport and storage.

### SUMMARY

According to the proposed technology at least the primary object is attained by means of the initially defined spray bottle having the features defined in the independent claim. Preferred embodiments of the proposed technology are further defined in the dependent claims.

According to a first aspect a spray bottle is provided, the spray bottle comprising: a bottle forming an interior space for holding a fluid, and a spray head comprising a nozzle, configured, or arranged, to spray the fluid contained in the bottle. The bottle has a bottom side configured, or arranged, for placement on a horizontal surface, and an oppositely arranged top side, and a finish, or spray head interface, attached to the top side. The spray head is a manually operated pump spray head and comprises a trigger actuator configured, or arranged, to move from a first position to a second position to spray fluid from the interior space through the nozzle at the transition from the first position to the second position. The spray head is mounted, or connected, to the finish, or spray head interface, of the bottle and the spray head is rotatable relative to the bottle to at least a first orientation in which the trigger actuator is prevented by the top side, to transition from the first position to the second position, and at least a second orientation in which the trigger actuator is allowed to transition from the first position to the second position.

It is specified above that the spray bottle comprises a spray head. The spray head comprises a nozzle, configured, or arranged to, spray the fluid contained in the bottle. The spray head and bottle thus form the spray bottle.

The spray head may be configured or arranged to spray the fluid contained in the bottle, or output the fluid, in different dosages and forms. For example, the spray head and nozzle may output, or eject, the fluid in the form of a spray, a jet, a mist, a stream or a foam. The fluid may be a liquid, or a gel. The fluid may comprise a cleaning agent, such as stain remover or a vehicle alloy wheel cleaner. The cleaning agent may have an acidic or basic pH. The cleaning agent may be a detergent or a fluid for soaking and softening dried particles, or contaminants on a vehicle interior or exterior surface.

The spray head comprises a pump, such as a piston pump, wherein the pump is operatively connected, or coupled, to a spray head trigger actuator. The trigger actuator may be operationally coupled, or connected, to the spray head body. This means that the trigger actuator may move, rotate, or transition, relative to the spray head. In one alternative the trigger actuator may be pivotally coupled, or connected, to a spray head body, and thus pivot relative to the spray body. When the trigger actuator pivots, and moves from a first to a second position, the pump pumps fluid from the pump to a nozzle, or nozzle opening, and ejects the fluid from, or through, the nozzle, or nozzle opening. It is understood that a nozzle faces in the spraying direction of the spray nozzle.

When the pump is a piston pump, comprising a piston moving inside a cylinder, the trigger actuator may be coupled, or connected to move the piston. Alternatively, the piston may be fixedly mounted to the spray head and the trigger actuator may be coupled, or connected, to move the cylinder.

The spray head may comprise a dip tube, or fluid transport conduit, that enables for fluid to flow, or be pumped, from the bottle to the pump. The spray head may further be arranged with a one-way valve that prevents backflow through the dip tube during the pump pumping stroke, wherein the piston pumps fluid from the cylinder to the nozzle. The spray head may further comprise a screen, or filter for preventing contaminants or particles in the fluid contained in the bottle from entering the dip tube, and/or spray head pump or nozzle.

The nozzle may comprise a nozzle face, facing in the spray direction, or the direction fluid is ejected from the nozzle. The nozzle opening may be arranged in the nozzle face. The nozzle face may be transverse to the nozzle spray direction. This means that the nozzle face, faces towards the object sprayed fluid is to be applied to, for example a car exterior surface.

It is understood that the spray head may be rotatable relative to the bottle at least a full revolution, or 360 degrees.

The spray head and the bottle may be arranged with a spray head interface. The spray head interface is configured to couple the spray head to the finish of the bottle. For example, the spray head interface may comprise female threads configured to interact, and thread to, male matching threads on the finish of the bottle. The spray head interface may thus comprise a first part, or finish, arranged on the bottle, and a second part, arranged on the spray head. As an alternative to the threaded spray head interface, the spray head may comprise a banjo-style spray head finish, or spray head interface; or the spray head may be crimped onto the bottle finish. The spray head interface may allow the spray head to rotate relative to the bottle or the spray head may be arranged with means for rotating the spray head relative to the bottle and spray interface.

The spray head may be arranged with a lock that prevents rotation of the spray head to assume the second orientation. In one example the spray head rotation lock, or orientation change lock. The rotation lock may be a spring loaded detent lock that engages the spray head and the bottle head spray interface. Alternatively, the rotation lock may be integrated, or built, into the means of the spray head that provides, or allows, rotation of the spray head relative to the bottle and spray interface.

To disengage the rotation lock, and to allow the spray head to rotate and reorient the spray head into a second orientation, the spray head may be pressed down in a direction towards the spray bottle top surface to disengage the spray lock, after which rotation and orientation of the spray head into the second orientation is allowed. When the spray head is rotated from the second orientation to the first orientation, wherein the spray head is at, or arranged in, the first orientation, the rotation lock reengages the spray head and locks the spray head in the first orientation. Alternatively, the detent may be implemented so that the spray head is pulled away from the bottle, in a direction upwards and away from the top surface, to disengage the rotation lock and allow rotation of the spray head from the first orientation into the second orientation. The spray head rotation lock provides an improved leakage prevention in that the spray head in the first orientation, is prevented from being rotated, or reoriented, from the first orientation to the second orientation by the detent lock.

It is specified above that the spray head is a manually operated pump spray head. Worded differently, the pump of the spray head is operated manually, by a user, by actuation of the trigger actuator. It is further specified that the spray head is a manually operated pump spray head and comprises a trigger actuator configured to move from a first position to a second position to spray fluid from the interior space through the nozzle at the transition from the first position to the second position. Worded differently, during the transition of the trigger actuator from the first to the second position, the pump moves from a first pump piston position to a second pump piston position. The first and second pump piston position thus forms part of a pump piston stroke. Worded differently, at the transition, or during the transition, from the first position to the second position the pump is actuated to spray fluid from the nozzle.

The pump may be a dual stroke piston pump, pumping fluid both during a transition from the first to the second pump piston position as well as during transition from the second to the first pump piston position. The trigger actuator and/or the piston of the pump may be spring loaded and biased to assume a first position. Worded differently, the spray head comprises a spring biasing the trigger actuator to assume the first position, or a rest position. The spring may be a coil, or helical spring. The spring biases, or applies a force, to move the trigger actuator into the first position, when the trigger is released by a user. The position the trigger actuator assumes by being biased by the spring, may be the first position, or a rest position. The first position may be the same as the rest position, or the first position may be a different position. The spring may form part of the spray head piston pump. For example, the pump piston return spring may form the trigger actuator biasing spring. This enables the biasing spring to provide both a pump end of stroke return force and to bias, or force, the trigger actuator to assume the first end position, or rest position. By biasing the trigger actuator to assume the rest position it is ensured that the spray head can be freely rotated relative the bottle without the trigger actuator interfering, or contacting, the bottle, when the trigger actuator is released, by an operator.

It is understood that the trigger actuator may transition between a first position and a second position. The trigger actuator may be pivotally coupled to the spray head body and arranged to pivot around a pivot axis at a transition between the first position and the second position. Worded differently, the trigger actuator may pivot around a pivot axis, or rotation axis, when the trigger actuator transitions between the first position to the second position. The trigger actuator may thus rotate in relation to the pivot axis at the transition from the first position to the second position.

Alternatively, the trigger actuator may be coupled, or connected, to the spray head body and arranged to move linearly, or translate, along a transition axis, in relation to the spray head body, at the transition from the first position to the second position. The spray head body may have a guide slot, and the trigger actuator may have protrusions that engage with and is guided by the guide slot. The guide slot may be aligned with the transition axis. The guide slot may thus define the transition axis.

At the transition of the trigger actuator from the first position to the second position, the pump piston may move from the start of the pump stroke to the end of the pump stroke.

It is understood that the trigger actuator may be coupled to the spray head by a pivot axle or a pivot pin. The pivot axle or pivot pin define the pivot axis. For example, the trigger actuator may comprise a pivot axle that connects to matching pairs of opening, or recesses in the spray head. Alternatively, the trigger actuator may comprise an opening, or through hole, and the spray head may comprise matching openings, or through holes. When the trigger is arranged such that the opening on the trigger actuator and the openings on the spray head align, a pivot pin may be inserted, or guided through, the aligned openings to pivotally couple, or connect, the trigger actuator to the spray head.

The trigger actuator may be connected to the pump with mechanical play. This means that the first position may be different from a trigger actuator end position, or rest position. The trigger actuator may transition, or be moved, from the rest position to the first position before the trigger actuator engages the piston of the pump.

Worded differently, the mechanical play between the trigger actuator and the pump may result in that forced actuation of the trigger actuator when the spray head is in the first position, or rest position, will not result in the trigger actuator pivoting far enough to reach the trigger actuator first position. The trigger actuator can thus not be pivoted enough for the trigger actuator to take up the mechanical play and engage and transfer force to actuate the spray head pump.

The second position of the trigger actuator may be an end position, corresponding to the end of stroke of the pump.

It is understood that the trigger actuator may extend from the pivot axis to form a grip. The grip may be arranged between the pivot axis and an outermost, and distal to the pivot axis, trigger tip. The grip provides an interface for actuating the trigger actuator, by application of a force from at least one finger of a user's hand. The trigger actuator may form a lever for actuating the pump. The grip, and grip surface, may be arranged with indentations, recesses, protrusions, serrations, ridges, or similar irregularities in the surface to increase friction and promote an improved grip.

There is a first distance between the pivot axis to the top side. There is a second distance between the pivot axis and the trigger tip. It is understood that the first distance may be smaller than the second distance.

It is understood that the first distance is a shortest linear distance, parallel to a top side surface normal, or transverse to the top side, between the axle the trigger actuator, or trigger, pivots around, or pivot axis, to the top side, or top surface, of the bottle.

The second distance is the shortest linear, and parallel to a top surface normal, distance between the top side, or top surface, of the bottle and the trigger tip.

The first distance being smaller than the second distance provides for the trigger to be prevented from moving, or transitioning, from the first position to the second position when the spray head is rotated and arranged in the first orientation. Worded differently, with the spray head in the first orientation, the trigger, or the trigger tip, engages the top side of the bottle at an attempted transition from the first position to the second position of the trigger actuator and prevents a transition to the second position. This prevents the pump from unintentionally being activated during storage or transport and prevents undesirable leakage.

The first distance may preferably be 10-40% longer than the second distance, more preferably in the range of 15-35%, or more preferably 20-30%, such as 25%. Worded differently, the first distance may be 110-140% of the second distance, more preferably in the range of 115-135%, or more preferably 120-130%, such as 25%.

There is a third distance between the top side and the trigger tip. The third distance is a shortest distance between the top side, or top side outer surface, or external surface, and the trigger actuator tip in the first position, or rest position.

The third distance may be in the rage of 1-8 mm, preferably in the range of 2-6 mm, or 5 mm. Providing a third distance between the top side and the trigger actuator tip in the first position, or rest position, provides for relaxed manufacturing tolerances for the spray head and the bottle. The third distance ensures that the spray head can freely rotate relative the bottle to assume the first and the second orientation without the trigger tip contacting the bottle.

The third distance discussed above also apply to when the trigger actuator is coupled, or connected, to the spray head body and arranged to move linearly, or translate, along a transition axis, in relation to the spray head body, at the transition from the first position to the second position.

It is specified above that the bottle forms an interior space for holding a fluid. Worded differently, the bottle forms an interior space for holding the fluid to be sprayed. The bottle is made from a material that is suitable for containing the fluid used for the purpose. For example, the bottle may be made of plastic material. The material is preferably resistant to degradation or corrosion from the fluid contained in the bottle. Alternatively, the bottle may be made of glass.

The bottle may be a non-rotational symmetric bottle. It is understood that the bottle may be a monolithic structure.

It is specified that the bottle has a bottom side configured for placement on a horizontal surface, and an oppositely arranged top side, and a finish. Worded differently, the bottle comprises a bottom side adapted for placing the bottle in a first orientation onto a horizontal and planar surface. The first bottle orientation may be referred to as a standing orientation. Thus, the bottom side of the bottle is in contact with the horizontal surface when the bottle is in the first orientation or standing.

It is specified that the bottle has, or forms, an oppositely, to the bottom side, arranged top side. Worded differently, the top side, or top surface, is arranged opposite from the bottom side of the bottle. When the bottle is in the first orientation, standing, on the horizontal surface, the top side is positioned further away from the horizontal surface than the bottom side, and the top side comprises an exterior surface that faces away from the horizontal surface.

It is specified that the bottle has, or comprises, a finish, or spray head interface, attached to the top side.

It is understood that the bottle may have a first side and a second side, that are arranged transverse to the bottom side and face in opposite directions. The bottle may have a third side and a fourth side that are arranged transverse to the bottom side and face in opposite directions. The third or fourth side may be transverse to the first and/or second sides. The first side may be connected, or joined, to the top side, bottom side, third side and the fourth side. The second side may be connected, or joined, to the top side, bottom side, third and fourth side. The third side may be connected, or joined, to the top side, bottom side, the first side and the second side. The fourth side may be connected, or joined, to the top side, the bottom side, the first side and the second side.

Worded differently, the bottle may have a first side, a second side, a third side, and a fourth side that together with the bottom side and the top side jointly enclosed the interior space formed by the bottle, wherein the first side and the second side face in opposite directions, the third side and the fourth side face in opposite directions.

It is understood that the first side, second side, third side, and fourth side, bottom side, and top side face in different directions. Worded differently, the first side may face in a first direction, the second side may face in a second direction, the third side may face in a third direction, and the fourth side may face in a fourth direction. The first direction and the second direction may be aligned, or parallel, and opposite. The third direction and the fourth direction may be aligned, or parallel, and opposite. The first direction and the second direction may be transverse, or perpendicular, to the third direction and the fourth direction. The bottom side may face in a fifth direction, and the top side may face in a sixth direction. The fifth and sixth direction may be aligned, or parallel, and opposite.

It is specified above that in the trigger actuator is prevented by the top side of the bottle to transition from the first position to the second position in the first orientation of the spray head. This means that the part of the bottle forming the interior space for holding the fluid prevents the transition from the first position to the second position. The top side together with the trigger actuator thereby may form the spray lock, or spray prevention arrangement. It is understood that when the spray head is rotated into the first orientation of the spray head and the trigger actuator is actuated, the trigger may make contact with, and be prevented by, the top side of the bottle to transition to assume the second position of the trigger actuator. Accidental spraying may thereby be prevented.

This is advantageous since no specific spray lock is needed to be integrated into the spray head itself. In addition, it provides for a more simple and more compact spray head, as well as a smaller space footprint of the spray bottle.

The first side, the second side, the third side, and the fourth side may be transverse to the bottom side.

The sides of the bottle, or the top side, bottom side and first, second, third and fourth sides may outline, or define, a cuboid, or rectangular prism.

It is understood that the first side of the bottle may define a first surface facing in a first direction, the second side of the bottle may define a second surface facing in a second direction, the third side may define a third surface facing in a third direction, and that the fourth side may define a fourth surface facing in a fourth direction.

The top side may define a planar geometry. The bottom side may define a planar geometry. The top side and bottom side planes may be parallel. The bottom side may be concave and a rim of the bottom side, or outer edges defining the bottom side, may lie in the plane. The top side may be formed by a portion of the top side being planar and a portion of the top side being non-planar. For example, the top side may be formed by a first portion having a two-dimensional surface lying in a plane and a second portion having a curved shape not lying in the plane. The finish, or spray head interface, of the bottle may be arranged in the first portion, or the planar portion of the top side.

It is specified above that the trigger actuator may be coupled, or connected, to the spray head body and arranged to move linearly, or translate, along a transition axis, in relation to the spray head body, at the transition from the first position to the second position. The transition axis may be non-parallel to the top side, or top side planar geometry. This has the effect that when the spray head is in the first orientation, trigger actuator is prevented, by the top side, to transitions from the first position to the second position. The transition axis may be arranged at an angle, or incline, relative to the top side, or top side planar geometry. The angle, or incline may be in the range of 10 degrees to 45 degrees, such as 30 degrees. This has the effect that the trigger actuator, and trigger tip, moves downwards, and towards, or closer, to the top side when the trigger actuator transitions from the first position to the second position.

The first side may define a planar geometry. The third side may define a planar geometry. The first and second side may be parallel and abreast. The fourth side may define a planar geometry.

It is understood that the bottle has a height, a length and a width. The height of the bottle may be defined as the distance between the top side and bottom side, measured transverse to the bottom side and/or top side. The height of the bottle, may be in the range of 8-25 cm.

The length may be defined as the distance between the third side and the fourth side measured transversely to the third side, along the bottom side of the bottle.

The width, or depth, or thickness, of the bottle may be defined as the distance between the first and second side, measured transversely to the first and second side.

The length and width may be the same for bottles configured to contain different amount of fluid. For example, when the length and width is the same, the volume of fluid a bottle can contain may be adjusted, or varied, by manufacturing the bottle with different heights. The width, or depth, or thickness, may be a 25-50% of the width of the bottle. The bottle may contain 0.3 L of fluid or more. For example, the bottle may contain 0.5 L or more. Preferably, the bottle may contain 0.3-1.5 L of fluid.

The fourth side may be arranged transverse to the bottom side or the top side. An angle between the fourth side and the top side may thus be a right-hand angle, or 90 degrees. The fourth side may join, or connect to, the top side and define an edge. The edge may be a rounded edge. The rounded edge may have a radius R2. The radius R2 may be 10%-90% of the width of the bottle. Worded differently, the top side may transition into the fourth side, by a transition surface, and the transition surface may outline a rounded bottle edge having a radius R2. Worded differently, the top side transitions to the first side. The transition may be rounded and smooth, and free of a sharp, or distinct, edge in a direction normal to the third or fourth side.

The transition, or the transition surface, may be outlined by a quarter circle shaped cylinder geometry having a radius R2, and extending, or having a height, transverse to a first or second side.

Alternatively, the radius R2 may be 10-30% of the length of the bottom side or top side of the bottle, or 10-30% of the width of the bottle.

The third side may be convex and outline, or define, a half-cylindrical geometry. The half-cylindrical geometry may be a half-elliptical cylinder, such as a circular cylinder. The half-cylindrical geometry may have a cylinder axis that is transverse to, or normal to, the bottom side.

The third surface may be defined by a smooth, continuously bulge, extending between the top side and the bottom side. The bulge may have a half-circular shape. The half-circular shape may define the base of a cylinder. The cylinder may extend between the top side and the bottom side of the bottle. The cylinder may be smooth and continuous between the top side and the bottom side of the bottle. This means that the cylinder is devoid of any serrations, protrusions or recesses in the surface, between the top side and the bottom side.

The third side joins, or connects to, the bottom side, the top side, the first side and the second side. The third side being outlined, or defined, by a bulging, or convex, half-cylinder extending between the bottom side and top side, provides for the bottle to be gripped by the fingers and palm of a user and improves handling and use of the bottle.

The bottle further comprises a finish, or bottle spray head interface. The finish, or spray head interface, is configured, or adapted for connecting the bottle to the spray head. The finish thus forms an interface for attaching the spray head to the bottle. The interface may be mechanical threads or a bayonet coupling allowing the spray head to be unscrewed, or decoupled, from the bottle for refilling of the bottle. Alternatively, the interface may be a fixed interface, preventing the removal of the spray head from the bottle, such as crimping of the spray head to the finish.

The finish may be attached directly to the bottle top side. The bottle may thus be referred to as neckless, free from a neck arranged between the bottle top side and the finish. Alternatively, the finish may be arranged, or attached to, or formed, on a bottle neck extending outwardly from the bottle top side.

The finish and bottle may be made from the same material. The spray head and finish may form one monolithic body. The bottle may be manufactured by blow molding, or injection blow molding. The finish, spray bottle interface, and the body may be formed in a joint manufacturing step, using a joint manufacturing method.

The finish is attached to the top side of the bottle. Worded differently, the finish forms a part of the bottle. The finish extends outwardly from the bottle top side. The finish has the outline of a cylinder with an opening formed through the top side.

It is specified above that the spray head is mounted, or connected, to the finish, or spray head interface, of the bottle and that the spray head is rotatable relative to the bottle to at least a first orientation and a second orientation. The spray head is thus rotatably mounted relative to the bottle and may rotate relative to the bottle. The spray head may be rotatable around a rotation axis. The spray head may be rotatable around a full rotation, or 360, degrees around the rotation axis.

The spray head is rotatable in relation to the bottle to assume at least a first orientation and a second orientation. The first orientation is an orientation in which the trigger actuator is prevented by the top side, to transition from the first position to the second position. The first orientation may thus be referred to as a leakage prevention, or trigger actuator and/or pump blockage orientation.

It is further specified above that the trigger actuator may be pivotally coupled to the spray head body and arranged to pivot around a pivot axis at a transition between the first position and the second position. The pivot axis may be transverse to the spray head rotation axis. Alternatively, the pivot axis may be transverse to the top side, or top side planar geometry.

The finish, or spray bottle interface, may be arranged adjacent, or at, the third side of the bottle. This means that the finish is arranged, or positioned, on the bottle closer to the third side than to the fourth side. The finish is thus offset from a top side surface center. This is advantageous in that when the spray head is rotated and arranged in the second orientation, the trigger actuator and the spray nozzle, extends away from the bottle.

The top side may be defined by a plurality of surface normal vectors extending outwardly from the top side. With the spray head in the first orientation, at least one surface normal vector may intersect the spray nozzle and trigger actuator, or trigger tip. Worded differently, the top side is defined by at least one surface normal that extends outward relative to the bottle and intersects the spray nozzle and trigger actuator, with the spray head in the first orientation.

This means that the spray head nozzle and trigger actuator is arranged above the top side surface. Thus, the trigger actuator is prevented from transitioning from the first position to the second position.

By the trigger actuator or spray head nozzle intersecting at least one top side surface normal, at least one infinitely long surface normal of the top side surface passes through at least a portion of the spray head nozzle or the trigger actuator, and in particular the trigger actuator tip.

When the spray head is rotated and positioned, or arranged, in the first orientation, a nozzle face, may face in the direction that the fourth side faces. Worded differently, the nozzle spraying direction may be aligned with a direction the fourth side faces when the spray head is arranged in the first orientation.

In the second orientation of the spray head, the nozzle may face in the same direction as the first, second or third side is facing. It is understood that a nozzle faces in the spraying direction of the spray nozzle. In the second orientation of the spray nozzle, the spraying direction may be aligned with and face in the first direction, the second direction, or the third direction.

In one example, the spray head is rotatable relative to the bottle to a first orientation in which the trigger actuator is prevented to transition from the second position to the first position. Worded differently, when the spray head is in the second orientation, the trigger actuator may be actuated and moved into the second position to spray fluid from the spray head nozzle. Maintaining, or holding, the trigger actuator in the second position, and rotating the spray head relative to the bottle into the first orientation, the trigger actuator may be arranged in a blocked state, wherein the trigger actuator is prevented to transition from the second position to the first position. Accordingly, in the example the trigger actuator may be locked against the top side, and prevent the trigger actuator from returning to the first position. This in turn prevents accidental spraying from the nozzle of the spray head. Hence, the bottle and spray head may be configured to prevent the trigger actuator from transitioning from the first state to the second state, and from the second state to the first state when the spray head is rotated to assume the first orientation.

When the spray head is rotated and positioned, or arranged, in the second orientation, a nozzle face, may face in a direction the first, second or third side faces. This means that the nozzle face is aligned with, the first, second or third side, and faces in the direction of the first, second or third side, or surfaces.

It is further understood that when the spray head is positioned, or arranged, in the second orientation the spray head is arranged transverse to the first and/or second side. This means that in at least one second orientation, the spray head is rotated to an orientation wherein the spray head is transverse to the first and/or second side and faces in the same direction as the first or second side.

The first orientation may be one of a plurality of first orientations. The plurality of first orientations may be delimited by a first sector around the axis of rotation of the spray head. For example, the first sector may comprise a range of 45-160 degrees of the full rotation, or 360 degrees. The size of the first sector may depend on the width of the bottle. When the spray head is oriented into an orientation within the first sector, the trigger actuator is prevented from transitioning from the first to the second position.

The second orientation may be one of a plurality of second orientations. The plurality of second orientations may be delimited by a second sector around the axis of rotation of the spray head. For example, the second sector may comprise a range of 200-315 degrees. When the spray head is oriented into an orientation within the second sector, the trigger actuator is allowed, and thus not prevented, from transitioning from the first to the second position for spraying fluid from the spray bottle.

The size of the continuous first and second sector may depend on at least the width of the bottle.

The first sector may be smaller, or may be delimited by a range of angles being smaller, than the second sector.

In a further example, the bottle is a perfume bottle. The perfume bottle may have a height om 4-8 cm, and contain a volume of at least 30 ml up to 100 ml. The perfume bottle may share features with the bottle according to the first aspect. Worded differently, the perfume bottle may be a miniaturized bottle adapted to contain and spray perfume instead of a car detailing fluid.

In a further example, the bottle is a liquor bottle. The liquor bottle may share the size and features of the bottle according to the first aspect, however the liquor bottle may comprise an alternative spray head. The spray head may be modified for pouring a liquid fluid from the liquor bottle instead of spraying the liquid fluid. The spray head may be modified by removal of the pump mechanism, and replacing the pump mechanism and dip tube with a trigger controlled valve. When the liquid fluid is to be poured from the bottle into a glass, the spray head is rotated to orient the spray head in the second orientation. When the bottle is tilted and the trigger actuator is moved to the second position, a valve inside the spray head is opened, and arranged in an unblocked state, allowing the fluid to be poured into the glass. In this example, the bottle has the width, height, and length to contain 0.3 L to 1.5 L of fluid.

Both the perfume bottle and the liquor bottle may comprise the rotation lock disclosed in relation to the spray bottle, to lock and prevent rotation of the spray head from the first orientation into the second orientation.

### BRIEF DESCRIPTION OF THE DRAWINGS

A more complete understanding of the abovementioned and other features and advantages of the proposed technology will be apparent from the following detailed description of preferred embodiments in conjunction with the appended drawings, wherein:

FIG. 1 is a perspective view of the spray bottle;

FIG. 2 is a top view of the spray bottle with the spray head in a first orientation;

FIG. 3A is a top view of the spray bottle with the spray head in a second orientation;

FIG. 3B is a side view of the bottle shown in FIG. 3A;

FIG. 4A is a top view of the bottle with the spray head in the first orientation;

FIG. 4B is a side view of the bottle in FIG. 4A;

FIG. 4C is a side view of the bottle shown in FIG. 4A;

FIG. 5A is a top view of the spray bottle in a further second orientation;

FIG. 5B is a side view of the bottle shown in FIG. 5A;

FIG. 6 is side view of the spray head with dip tube;

FIG. 7A is side view of the finish and one part of the spray head interface according;

FIG. 7B is a side view of an alternative bottle finish arranged on a bottle neck portion;

FIG. 8A is a top view of a spray bottle with the spray head arranged in one of a plurality of first orientations;

FIG. 8B is a side view of the bottle shown in FIG. 8A;

FIG. 9 is a top view of the spray bottle showing first orientation sector and second orientation sector;

FIG. 10A is partial side view of the spray head wherein the trigger actuator is in the first position; and

FIG. 10B is a partial view of the spray head wherein the trigger actuator is in the second position being blocked from transitioning from the second position to the first position by the bottle top side;

FIG. 10C is a partial view of the spray head wherein the trigger actuator is in the first position, or rest position, showing the third distance between the trigger tip and the top side; and

FIG. 11 is a partial view of the spray head wherein the trigger actuator is a linear trigger actuator.

### DESCRIPTION OF THE DRAWINGS

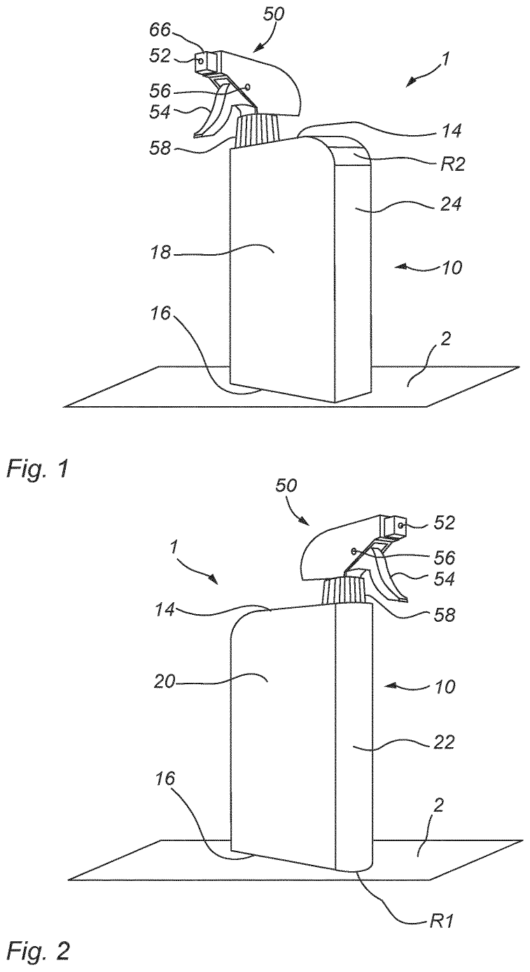

FIG. 1 shows the spray bottle 1, comprising a bottle 10 and a spray head 50. The bottle 10 is shown positioned, or arranged on a horizontal surface 2, or horizontal plane 2. The bottle 10 is shown standing on the horizontal surface 2, having at least a portion of the bottom side 16 of the bottle in contact with the horizontal surface 2.

The spray bottle 1 is adapted to contain a fluid in the bottle 10 and to spray the fluid through a nozzle 52 of the spray head 50. This is performed by moving a trigger actuator 54 of the spray head 50, from a first position to a second position. The trigger actuator 54 is shown as a hand, or finger, operated trigger actuator 54. The trigger actuator 54 is pivotally coupled, or connected, to the spray head by a pivot axle 56.

The spray head 50 interfaces, or attaches, to the bottle by a finish 58, or a spray bottle interface 58. The finish, or spray bottle interface 58, is shown as a threaded interface. The interface allows the spray head 50 to be unthreaded, unscrewed, or decoupled, from the bottle 10 for filling or refilling of the bottle 10.

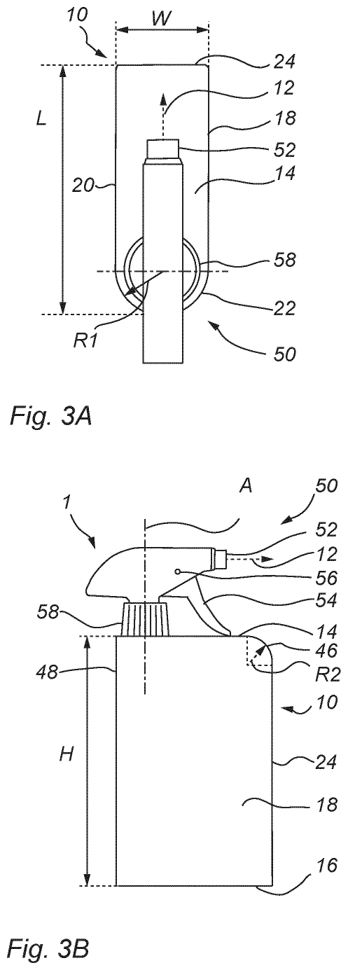

The spray head interface 58, provides for the spray head 50 to rotate in relation to the bottle 10. The rotation of the spray head 50 in relation to the bottle 10, is around a central axis A, shown in FIGS. 3B, 4B, 4C, 5B, of the opening of the bottle, or the finish 58 or spray head interface 58.

The spray head 50 is thereby rotatable in relation to the bottle 10 to assume at least a first orientation and a second orientation. FIG. 1 shows the spray head arranged in the second orientation, or an orientation the spray head is rotated to when the spray bottle is in use, spraying the fluid from the spray head nozzle 52. The spray nozzle further comprises a nozzle face 66. The nozzle face 66 faces in a direction the spray head sprays a fluid from the nozzle 52. In FIG. 1 the nozzle face 66, faces in the same direction the first side 18 faces.

FIG. 1 shows the bottle 10 having the outline shape of a prism, or rectangular cubic, or rectangular cuboid shape.

The bottle has a top side 14 and a bottom side 16, a first side 18, a second side 20, a third side 22 and a fourth side 24 that together forms, or defines, the bottle 10. The first 18 and second side 20 extend in parallel and are arranged oppositely of each other. The first 18 and second 20 side are arranged transversely to the top side 14 and bottom 16. The first 18 and second 20 side are joined with the top side 14 as well as the bottom side 16. The third 22 and fourth 24 side extend in parallel and are arranged oppositely each other. The third 22 and fourth 24 side are joined with the top side 14, the bottom side 16, the first 18 and the second 20 side. The first 18 and second 20 side have the same area size. FIG. 1 further shows that the edge between the top side 14 and the fourth side 24 is rounded having a radius R2. Worded differently, the top side 14 transitions to the fourth side 24. The transition is rounded and smooth, and free from a sharp, or distinct, edge in a direction transverse to the first 18 or second side 20.

FIG. 2 shows the bottle of FIG. 1 from a second perspective. FIG. 2 shows the third side 22 joined with the first side 18, second side 20 as well as the bottom side 16 and the top side 14. The third side 22 is rounded, having a continuous round with a radius R1 along the height H of the bottle. Worded differently, the rounded surface of the third side 22 takes the shape of a half-circular cylinder, extending from the bottom side 16 to the top side 14. The half-circular cylinder has the radius R1. The third side 22 defines a smooth surface, configured for being gripped and held by the palm and fingers of a user's hand. The radius R1 of the rounded third side 22 is shown as being equal to half of the width W of the bottle 10.

FIG. 3A shows a top-down view of the spray bottle 1 in FIG. 1, and FIG. 3B shows a side view of the spray bottle 1 of FIG. 1. In FIGS. 3A-3B, the spray head 50 is arranged in a first orientation corresponding to a spray head leakage prevention, or trigger actuator blockage, orientation.

FIG. 3A-3B shows the spray head 50 orientated and aligned parallel with the first 18 and second 20 side. The spray head is transverse to the fourth side 24. The trigger actuator 54 and nozzle 52 are arranged above the top side 14 of the bottle 10. The trigger actuator 54 and nozzle 52 thereby intersect with a surface normal of the top side 14. By the spray head 50 assuming the first orientation, the trigger actuator 54 is prevented by the top side 14 from pivoting from a first position to a second position, to actuate and pump fluid from the spray head pump. The first orientation is thereby a trigger actuator 54 blocking, and leakage preventing orientation. The first orientation is one of a plurality of orientations in which the trigger actuator is prevented from moving from the first to the second position.

The first side 18 is planar and defines a first plane. The second side 20 is planar and defines a second plane. The width W, or thickness, of the bottle 10 is defined by the transverse distance between the first 18 and second 20 side, or first and second plane.

The third side 22 of the bottle is rounded having a radius R1. The third side 22 is convex, and bulges outwards, away from the interior space, of the bottle 10. The bulge, or convex, forms the shape of a half-cylindrical cylinder geometry, that extends uninterrupted from the bottom side 16 to the top side 14. The third side 22 being convex and bulging outwards, define an outermost ridge 48 of the third side 22. The length L of the bottle is defined as the transverse distance between the fourth side 24 and the ridge 48.

The spray head 50 is arranged adjacent the third side 22 of the bottle 10. The spray head 50 is shown as being arranged, off centered and closer to the third side 22 than the fourth side 24.

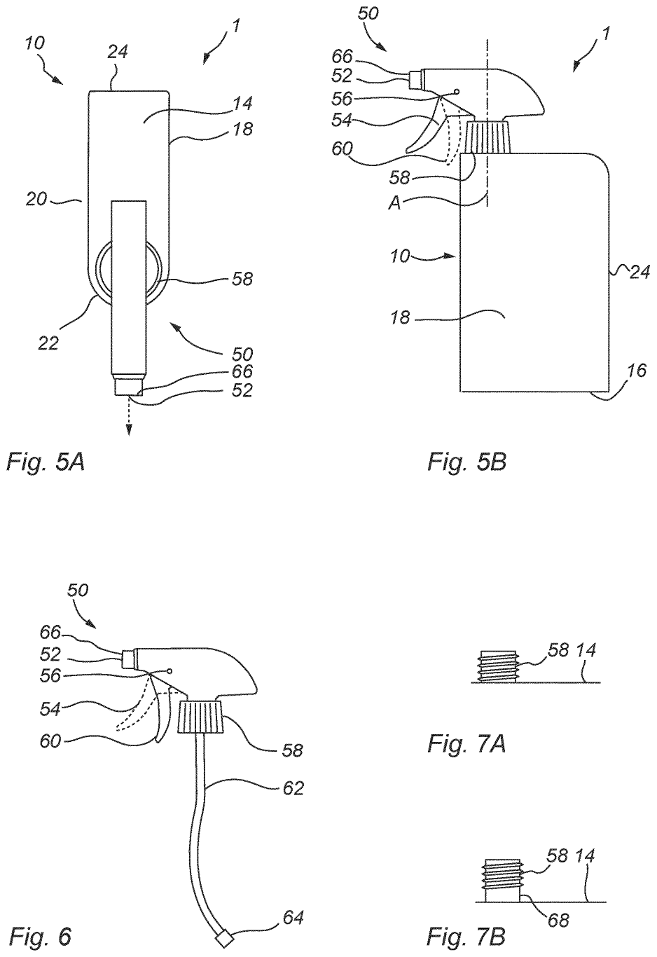

FIG. 3B shows the transition 46 between the top side 14 and the fourth side 24, or the rounded edge 46, having a radius R1. The transition 46 has the shape of a quarter circular cylinder geometry that joins the top side 14 and the fourth side 24. The transition 46, or rounded edge 46, provides improved ergonomics when the spray bottle spray head 50 and bottle 10 is arranged, and held by a hand of a user, in the configuration shown in FIG. 5B.

FIG. 3B further shows the bottle 10 having a height H, between the bottom side 16 and top side 14.

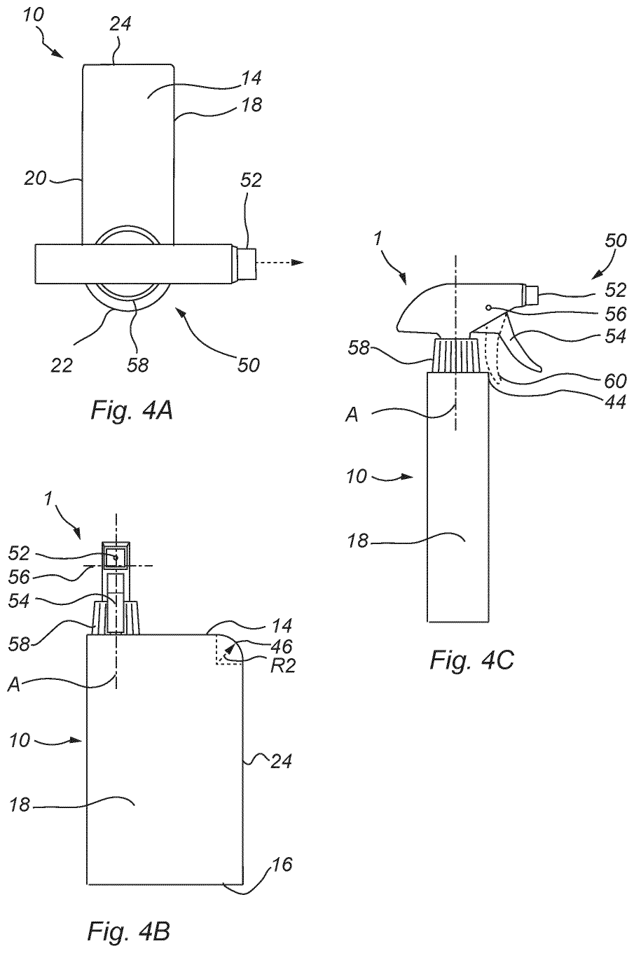

The spray head 50, or bottle finish 58, or spray head interface 58, provides for the spray head 50 to be rotatable around a rotational axis A shown in FIGS. 3B and 4B.

FIG. 4A shows a top-down view of the spray bottle 1 in FIG. 1 and FIG. 4B shows a side view of the spray bottle 1 in FIG. 1. In FIGS. 4A-4B, the spray head 50 is arranged in a second orientation corresponding to a position that allows, or enables, the trigger actuator to be actuated and for fluid contained in the bottle to be sprayed by the spray head from the spray head nozzle. FIG. 4C shows a side view facing the third side 22 of the arrangement of FIG. 4A and FIG. 4B.

In the second orientation shown in FIGS. 4A-4C, the spray head 50 is arranged parallel to the fourth side 24, and transverse to the first 18 and second 20 side. The spray head 50 faces in the direction the first surface 18 faces. The second orientation shown is thus at a right angle in relation to the first 18 and second 20 side. The second orientation shown is one of a plurality of second orientation, wherein the trigger actuator is freely movable from the first position to the second position, and operably arranged for spraying. FIG. 4A shows the nozzle 52 spraying direction 12. The nozzle spraying direction is transverse and faces in the direction the first side 18 faces.

FIG. 4C shows the trigger actuator 54 in the first position 54, as well as the second position 60, shown in dashes lines. In the second position 60, the trigger actuator 54 has pivoted around the pivot axle 56 to a position in which a lower portion of the trigger actuator 54 is at, and contacts the edge 44 joining the top side 14 to the first side 18. The end of stroke of the trigger actuator 54 may be controlled by the spray pump stroke, or the end of stroke of the trigger actuator 54 may be determined by the trigger actuator lower portion contacting the bottle, or the edge between the top side and the first side.

FIG. 5A shows a top-view of the bottle 1, wherein the spray head 50 is oriented in a further second orientation. FIG. 5B shows a side view of the bottle shown in FIG. 5A. The spray head 50 has been rotated around the rotation axis A and is shown aligned with the first 18 and second 20 side. The spray head nozzle face 66 faces in a direction away from the bottle 10, and in a direction the third side 22 faces. In the further second orientation 60, the trigger actuator 54 freely pivots from the first position 54 to the second position 60. FIG. 5A shows the nozzle 52 spraying direction 12. The spraying direction is transverse to the fourth side 24, or aligned with the first side 18 and second side 20, and faces in the direction the third side 22 faces.

FIG. 5B shows a side view of the bottle shown in FIG. 5A, viewed facing the first surface 18. FIG. 5B shows the trigger actuator 54 in the first position, as well as the trigger actuator 54 in a second position 60, the second position 60 shown with dashed lines.

FIG. 6 shows a side view of a spray head 50. The spray head 50 comprises a dip tube 62 configured to extend into the bottle interior space, and the bottle fluid, and act as a flow tube 62 for providing the spray head pump with fluid to be sprayed from the spray head nozzle 52. FIG. 6 further shows a dip tube filter 64 arranged at a position at the end of the dip tube 62 distal to the spray head 50.

FIGS. 7A-7B shows partial view of two examples of finish 58, or spray head interface 58, wherein FIG. 7A shows the finish 58 being neckless, or free from a neck, and extending from the top side 14. The finish 58 thus forms the complete bottle finish 58. FIG. 7B shows the finish 58, or spray head interface 58 being connected to the top side 14 of the bottle 50 by an intermediate neck 68. The length of the neck 68 may be adapted, or configured, depending on the spray head 50 used with the bottle 10. For example, when the spray head 50 comprises a trigger actuator with a longer trigger actuator, the neck may adjust to account for the longer trigger actuator such that the spray head may be rotated into the first orientation without the trigger actuator interfering with, or hitting, the bottle during rotation of the spray head.

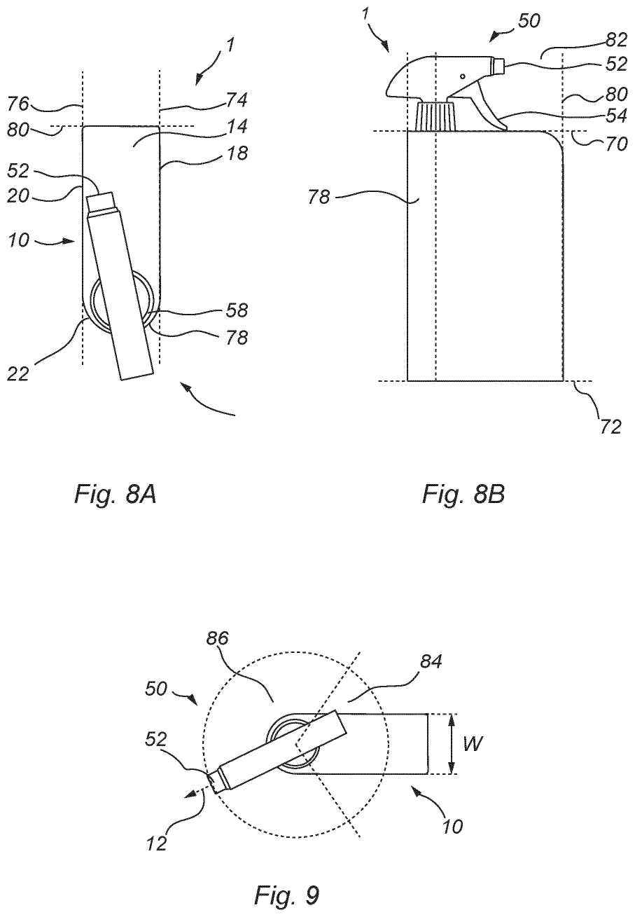

FIG. 8A shows a top view of the spray bottle 1 with the spray head 50 arranged in one of a plurality of first orientations, in relation to the bottle 10, and FIG. 8B shows a side view of the spray bottle 1 shown in FIG. 8A.

FIG. 8A shows that the first side 18 defines a first plane 74, and the second side 20 defines a second plane 76. The third side 22 defines a curved, or convex, half-circular geometric third plane 78. The fourth side 24 defines a fourth plane 80. The first 74, second 76, third 78, and fourth 80 planes intersect and form a delimited plane, corresponding to the top plane 70. An imaginary cylinder 82 extending outwardly from the top side 14 with a base corresponding to the delimited plane 70 is formed, or defined. The first orientation of the spray head 50 is an orientation around the rotational axis A wherein the spray nozzle 52, and/or trigger actuator 54 is oriented and lie within, or inside, the imaginary cylinder 82. The bottom side 16 of the bottle defines a bottom plane 72.

FIG. 9 shows a further example of the spray head 50 oriented, or rotated, in a second orientation, wherein the trigger actuator 54 is allowed to transition from the first position 54 to the second position 60. The second orientation is thus not a single orientation but a plurality of second orientations. Worded differently, the spray head is rotatable at least a full rotation, or 360 degrees, around the rotation axis A. The plurality of second orientations are formed by a continuous second sector 86. Correspondingly, the first orientation is one of a plurality of first orientations, formed by a continuous first sector 84. The first sector 84 is smaller, or is delimited by a range of angles being smaller, than the second sector 86. The first sector 84 may comprise a range of 45-160 degrees and the second sector may comprise a range of 200-315 degrees. The size of the continuous first 84 and second 86 sector depend on at least the width, or depth, or thickness, W of the bottle 10. FIG. 9 shows the nozzle 52 spraying direction 12. The spraying direction faces in the direction the third side 22 faces.

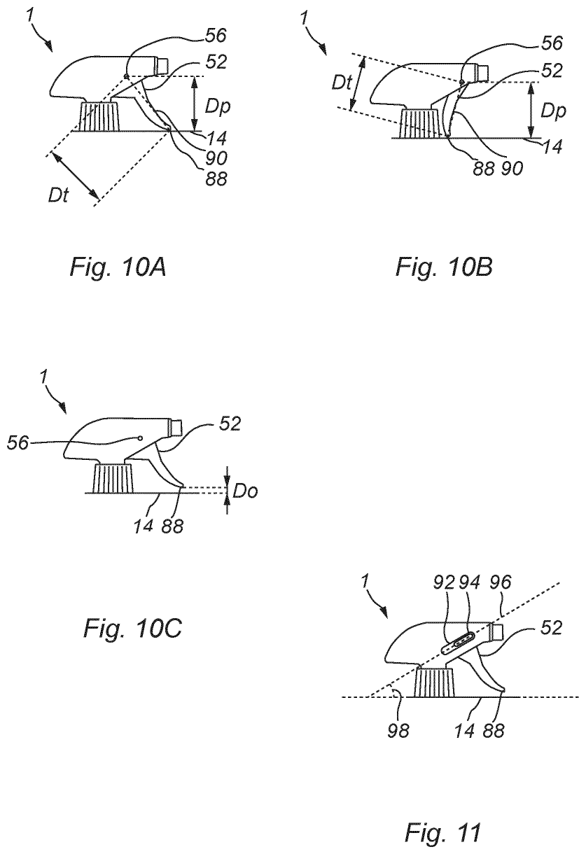

FIG. 10A, shows a partial view of the spray bottle 1, with the spray head 50, arranged on the bottle top side 14. The trigger actuator 52 pivots around the pivot axle 56, and the pivot axle 56 is arranged at a shortest distance Dp transverse from the top side 14. The trigger actuator 52 is shown having an outermost point from the pivot axis, the outermost point being a trigger actuator tip 88. Arranged between the tip 88 and the pivot axis 56 is a trigger grip portion 90, or surface 90. The grip portion 90 is adapted, or configured, to be gripped by at least one finger of a user, and pushed by the finger during spraying, to pivot the trigger actuator 52 around the pivot axle 56. A distance Dt between the pivot axle 56 and the tip 88 is shown. The distance Dp between the pivot axle 56 and the top side 14 is smaller than the distance Dt between the pivot axle 56 and the trigger actuator tip 88. As long as the distance Dp is smaller than the distance Dt, the trigger actuator 52 will be prevented from transitioning from the first position to the second position when actuated, or pressed.

FIG. 10B shows an alternative embodiment of FIG. 10A, wherein the trigger actuator 52 is prevented from transitioning from the second position to the first position, by the trigger actuator tip interfering, or being blocked, by the top side 14. The trigger actuator 52 blocking, or leakage preventing function, may thus also prevent the trigger actuator 52, and the spray head pump, from returning to the first position after being arranged in the second position and orienting the spray head 50 into one of the plurality of first orientations.

Corresponding to FIG. 10A, the distance Dp from the pivot axle 56 to the top side 14 is smaller than the distance Dt from the pivot axle 56 to the trigger actuator tip 88.

FIG. 10C is a partial view of the spray head 50 and bottle 1 wherein the trigger actuator is in the first position 54, or rest position, showing the distance Do between the trigger tip (88) and the top side (14) is shown.

FIG. 11 is a partial view of an alternative spray head 1 wherein the trigger actuator 52 is a linear trigger actuator. The trigger actuator 52 is coupled, or connected, to the spray head body and arranged to move linearly, or translate, along a transition axis 96, in relation to the spray head body, at the transition from the first position to the second position. The transition axis 96 is shown as being non-parallel to the top side 14. The trigger actuator is coupled or connected to a guide slot 92 arranged in the spray head body. The guide slot interacts with a protrusion 94 on the trigger actuator 52 that engages, and guides the trigger actuator 52 along the transition axis 96, when the trigger actuator 52 is actuated to transition from a first position to a second position. The transition axis 96 is arranged at an angle 98, or incline 98, relative to the top side 14 of the bottle. The angle 98, or incline 98, is shown to be about 30 degrees.

### ITEM LIST

1 spray bottle
2 horizontal surface, horizontal plane
10 bottle
12 nozzle spray direction
14 top side
16 bottom side
18 first side
20 second side
22 third side
24 fourth side
R1 radius of third side
R2 radius, rounded edge, or transition between fourth side and top
H bottle height
L bottle width
3 bottle width, or thickness, or depth
44 edge between top side and first side
46 edge between top side and fourth side
48 third side ridge
50 spray head
52 nozzle
54 trigger actuator, first position
56 pivot axle
58 finish, spray bottle interface
60 trigger actuator, second position
62 dip tube
64 dip tube filter
66 nozzle face
68 bottle neck
70 top plane
72 bottom plane
74 first plane
76 second plane
78 third plane
80 fourth plane
82 cylinder
84 sector of first orientations
86 sector of second orientations
88 trigger actuator tip
90 trigger actuator grip portion
92 guide slot
94 trigger actuator protrusion
96 transition axis
98 transition incline angle
Dp distance pivot axle to bottle top
Dt distance pivot axle to trigger actuator tip
Do distance trigger tip in first position to top side

1-15. (canceled)

16. A spray bottle, comprising:
a bottle container defining an interior space configured for containing a fluid, the bottle container having a bottom side and an opposite top side;
a spray head interface attached to the top side of the bottle container; and
a manually-operated pump spray head mounted on the spray head interface, the spray head comprising:
a nozzle configured to spray the fluid contained in the bottle container; and
a trigger actuator movable from a first position to a second position and configured to spray fluid from the interior space through the nozzle in response to movement of the trigger actuator from the first position to the second position;
wherein the spray head is rotatable relative to the container to at least a first orientation in which the trigger actuator is prevented by the top side of the bottle container from moving from the first position to the second position, and to at least a second orientation in which the trigger actuator is movable from the first position to the second position.

17. The spray bottle according to claim 16, wherein the spray head is rotatable relative to the bottle container to a first orientation in which the trigger actuator is prevented by the top side of the bottle container from moving from the second position to the first position.

18. The spray bottle according to claim 16, wherein the spray head comprises a spring that biases the trigger actuator to assume the first position.

19. The spray bottle according to claim 16, wherein the trigger actuator is pivotally coupled to the spray head and arranged to pivot around a pivot axis at a transition between the first position and the second position.

20. The spray bottle according to claim 19, wherein the trigger actuator has a trigger tip, wherein a first distance (Dp) between the pivot axis to the top side of the bottle container is smaller than a second distance (Dt) between the pivot axis and the trigger tip.

21. The spray bottle according to claim 19, wherein the trigger actuator has a trigger tip, and wherein a distance (Do) between the top side of the bottle container and the trigger tip, with the trigger actuator in the first position, is in the range of 1-8 mm.

22. The spray bottle according to claim 16, wherein the bottle container comprises:
a first side and an opposite second side that are transverse to the bottom side of the bottle container and that face opposite directions; and
a third side and an opposite fourth side that are transverse to the bottom side of the bottle container and that face opposite directions;
wherein the first side is connected to the top side, the bottom side, the third side, and the fourth side; and
wherein the second side is connected to the top side, the bottom side, the third side, and fourth side.

23. The spray bottle according to claim 22, wherein the fourth side is transverse to the top side, and wherein the top side includes a transition into the fourth side, the transition defining a rounded bottle edge having a radius (R2).

24. The spray bottle according to claim 22, wherein the third side is convex and defines a half-cylindrical geometry.

25. The spray bottle according to claim 22, wherein the spray head interface is adjacent the third side of the bottle container.

26. The spray bottle according to claim 16, wherein, with the spray head in the first orientation, at least one top side surface normal vector extends outwardly from the top side of the bottle container and intersects the spray nozzle and the trigger actuator.

27. The spray bottle according to claim 22, wherein, with the spray head in the second orientation, the spray nozzle faces in the same direction as does one of the first side, the second, side, and the third side of the bottle container.

28. The spray bottle according to claim 22, wherein, in the second orientation of the spray head, the spray nozzle faces in the same direction as does the fourth side.

29. The spray bottle according to claim 16, wherein the spray head is rotatable relative to the bottle container at least 180 degrees.

30. The spray bottle according to claim 16, wherein the spray head is rotatable relative to the bottle container at least 360 degrees.
